(19) United States
(12) Patent Application Publication
(10) Pub. No.: US 2012/0156464 A1
(43) Pub. Date: Jun. 21, 2012

(54) COVER GLASS FOR FLAT PANEL DISPLAYS

(75) Inventor: Kazutaka Ono, Tokyo (JP)

(73) Assignee: Asahi Glass Company, Limited, Chiyoda-ku (JP)

(21) Appl. No.: 13/324,100

(22) Filed: Dec. 13, 2011

(30) Foreign Application Priority Data
Dec. 16, 2010 (JP) 2010-280467

(51) Int. Cl. B32B 17/00; C03C 15/00

(52) U.S. Cl. 428/220; 65/30.1

(57) ABSTRACT

A cover glass for flat panel displays, which is difficult to be spontaneously destroyed is provided. The present invention relates to a cover glass for flat panel displays, obtained by chemically strengthening a glass obtained by a fusion process, in which the glass before chemical strengthening does not contain defects having a particle size of 40 μm or more, and the cover glass has an internal tensile stress of 30 MPa or more and a thickness of 1.5 mm or less.

### FIELD OF THE INVENTION

The present invention relates to a cover glass for flat panel displays and a method for producing the same.

### BACKGROUND OF THE INVENTION

In recent years, in flat panel displays (hereinafter referred to as “FPD”), there has been employed a structure of arranging a thin sheet glass in front of displays so as to become a region wider than an image display portion, thereby concealing a convex portion of a frame to improve the appearance.

In order to arrange a glass in front of displays, a method of separating a cover glass and an FPD panel has been used. However, in the method, the appearance is impaired by reflection between a glass and a layer of air. For this reason, a structure that a glass and an FPD panel are bonded with a resin or a pressure-sensitive adhesive sheet to decrease reflection at the interface is preferred.

In recent years, a large-sized television is preferred as a television for home use. In the case of using a method of directly bonding an FPD panel and a cover glass to a large-sized FPD having a size of 32 inches or more, an area of the cover glass is increased. As a result, in the case where a soda lime glass having a thickness of, for example, 2.5 mm is used, the weight of the body itself is increased, and load in transportation and installation is increased.

In view of the above, thin and lightweight glasses, for examples, glasses having a thickness of 1.5 mm, 1.1 mm and 0.7 mm, are used. When the thickness of a glass is reduced, strength is decreased. To solve this problem, use of a glass strengthened by a chemical strengthening method is essential (for example, Patent Documents 1 and 2)

Patent Document 1: JP-A-57-205343

Patent Document 2: JP-A-9-236792

### SUMMARY OF THE INVENTION

However, the chemically strengthened glass has tensile stress in the inside thereof. Therefore, it was seen that the chemically strengthened glass has the problems that in the case where defects such as contaminations are present in the tensile stress section, the defects become origin of the destruction, possibly leading to a risk bringing about spontaneous destruction. For this reason, in the case where contaminations having an expansion coefficient different from that of a glass and to which tensile stress is always applied are present in a glass (particularly, in the vicinity of a central portion in a sheet thickness direction), the contaminations lead to progress of cracks due to fatigue, leading to a risk bringing about spontaneous destruction.

In a cover glass of mobile phones, in the case where destruction causes during talking, a risk of injury is extremely high. In a large-sized television, an area causing such destruction is large. Therefore, the possibility of spontaneous destruction is high. Particularly, a cover of mobile information devices such as mobile phones is easy to be dropped. In such a case, there is the problem that those defects become origin of the destruction, and the possibility of damage of the cover glass is high.

Accordingly, an object of the present invention is to provide a cover glass for flat panel displays, which suppresses occurrence of defects in a tensile stress section of a chemically strengthened glass and is difficult to be spontaneously destroyed.

As a result of further careful investigations of the above problems, the present inventors have found that to reduce a risk by spontaneous destruction of a chemically strengthened glass, contaminations, particularly zirconia, should not be present in the vicinity of a glass central portion which possibly becomes a tensile stress section. They have further found that to achieve the above, improvement in melting and molding methods and/or composition of a glass to be chemically strengthened is effective, and have completed the present invention.

Namely, the present invention relates to the following items.

1. A cover glass for flat panel displays, obtained by chemically strengthening a glass obtained by a fusion process,

wherein the glass before chemical strengthening does not contain defects having a particle size of 40 μm or more, and

the cover glass has an internal tensile stress of 30 MPa or more and a thickness of 1.5 mm or less.

Hereinafter, the term “internal tensile stress” also simply refers to as “tensile stress” in the present specification.

2. The cover glass for flat panel displays according to item 1, wherein the glass before chemical strengthening contains ZrO₂ in an amount of 1.0% or less in terms of mol %.

3. The cover glass for flat panel displays according to item 1 or 2, wherein the glass before chemical strengthening is a glass containing 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂ in terms of mol %.

4. A flat panel display using the cover glass for flat panel displays according to any one of items 1 to 3 as a cover glass.

5. A method for producing a cover glass for flat panel displays by chemically strengthening a glass obtained by a fusion process,

wherein the glass before chemical strengthening does not contain defects having a particle size of 40 μm or more, and

the cover glass has an internal tensile stress of 30 MPa or more and a thickness of 1.5 mm or less.

6. The method for producing a cover glass for flat panel displays according to item 5, wherein the glass before chemical strengthening contains ZrO₂ in an amount of 1.0% or less in terms of mol %.

7. The method for producing a cover glass for flat panel displays according to item 5 or 6, wherein the glass before chemical strengthening is a glass containing 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂ in terms of mol %.

According to the present invention, in molding a glass in a production step of a glass to be chemically strengthened, incidence of defects in a glass to be chemically strengthened is decreased by avoiding a glass melt from contacting a zirconia-containing member, whereby occurrence of the defects in the tensile stress section of the glass to be chemically strengthened is suppressed and spontaneous destruction of a glass can be prevented.

### BRIEF DESCRIPTION OF THE DRAWINGS

FIG. 1 is a view showing the relationship between frequency of particle size of defects and incidence of cracks.

FIG. 2 is a side cross-sectional view of a display in one embodiment of the present invention.

FIG. 3 is a front view of FIG. 2. L indicates a diagonal screen size (inch).

FIG. 4 is a side cross-sectional view of a modified example of FIG. 2

### DETAILED DESCRIPTION OF THE INVENTION

The present invention is described in detail below.

### [Correlation Between Defects in Glass and Incidence of Cracks]

The purpose of chemically strengthening a glass is to bring about sufficient strength improvement. For this reason, both surface compression stress S and stress layer depth t must be large. Intensity of the chemical strengthening can be represented by internal tensile stress T calculated from the surface compression stress S and the stress layer depth t.

Specifically, when a thickness of a glass is defined as d, the correlation among the internal tensile stress T, the surface compression stress S and the stress layer depth t is represented by the following equation (I):

T=(S×t)/(d−2×t) (I)

In the uses of a cover glass for displays and the like, a thin sheet having a thickness d of 1.5 mm or less is used for reduction in weight.

In the case where the thickness d is 1.5 mm or less, the internal tensile stress is set to 30 MPa or more. This is because when the internal tensile stress is less than 30 MPa, the practical surface compression stress S cannot be incorporated in sufficient stress layer depth in the thin sheet having a thickness d of 1.5 mm or less.

When the internal tensile stress T is 30 MPa or more, the surface compression stress S or the stress layer depth t is sufficiently large, and sufficient improvement in strength is recognized. For this reason, the internal tensile stress T should be 30 MPa or more.

A glass for chemical strengthening is sometimes produced by a fusion process. However, as a result of observing the inside of the glass for chemical strengthening produced by the fusion process, the defects were observed. As a result of analyzing the composition of the defects, the defects were ZrO₂.

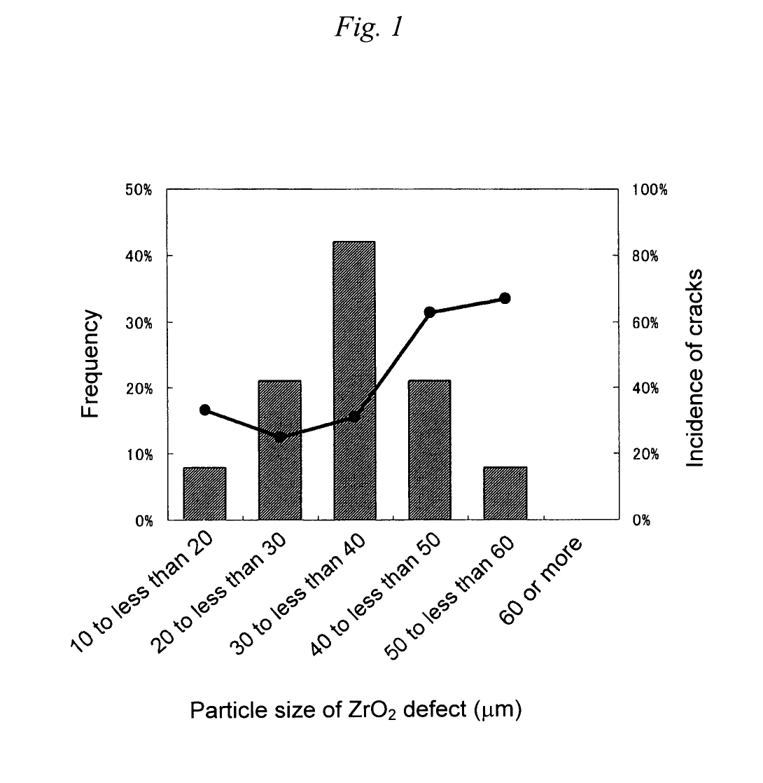

Particle size distribution of the defects of ZrO₂ (hereinafter referred to as “ZrO₂ defects”) is shown in FIG. 1. As a result of observing as to whether or not cracks are generated from the ZrO₂ defects, it was found that the incidence of cracks becomes rapidly high when the particle size (maximum diameter) of the ZrO₂ defects is 40 μm or more, as shown in a line graph of FIG. 1.

In a chemically strengthened glass, tensile stress is generated in the inside than the compression stress layer depth t, but stress concentration is difficult to occur only by the presence of nearly spherical defects. However, in the case where cracks are generated, stress concentration occurs at the tip of cracks by its tensile stress or by the addition of external force such as torsion. As a result, cracks gradually develop, ultimately resulting in spontaneous destruction.

However, in the case where defects having a particle size of 40 μm or more are not present in the glass sheet for chemical strengthening, a possibility of causing destruction is very small. For this reason, the defects having a particle size of 40 μm or more should be eliminated in order to suppress spontaneous destruction.

A method of eliminating defects includes a method of avoiding a glass from contacting a member containing zirconia (ZrO₂), or a method of decreasing zirconia concentration in a glass composition, thereby avoiding that zirconia is dissolved and becomes defects.

In the present description, the particle size of the defects in the glass being subjected to chemical strengthening is obtained by taking a photograph using an optical microscope and measuring the particle size using the photograph.

The internal tensile stress T of a chemically strengthened glass is obtained by measuring the stress layer depth t and the surface compression stress S using a surface stress meter FSM-6000 manufactured by Orihara Industrial Co., Ltd., and calculating the equation (I) from those values and the thickness t of a glass sheet measured with a micrometer or the like.

[Method for Producing Glass before Chemical Strengthening]

The cover glass for flat panel displays of the present invention is obtained by chemically strengthening a glass molded by a fusion process. The fusion process is one of basic techniques used in a glass production field for producing a glass sheet (U.S. Pat. No. 3,338,696 and U.S. Pat. No. 3,682,609).

The fusion process forms a glass sheet having a surface having excellent flatness and smoothness as compared with, for example, a slot down drawing process. For this reason, the fusion process has become particularly important in the production of a glass substrate used in the manufacturing of a liquid crystal display (LCD).

In the fusion process, a refined and homogenized glass melt is poured in an upper groove of a fusion pipe, and the glass melts overflowed at both sides of the fusion pipe are flown downward along an outer wall of a V-shaped fusion pipe. The glass melts overflowed from both sides are fused together and integrated at a section called a lower root of the fusion pipe, and are continuously molded as one thin sheet.

The fusion pipe used in the fusion process is exposed to high temperature and considerable mechanical load when the glass melt is overflowed from both sides of the fusion pipe. The fusion pipe is formed from a refractory so as to withstand those required states.

A refractory comprising zircon refractory (for example, ZrO₂, SiO₂, and ZrSiO₄) as the main component is generally used as the refractory. The zircon becomes zircon crystal, and the zircon crystal becomes the cause of contamination in a completed glass sheet. Occurrence of zircon crystal is further remarkable in a glass which must be formed at high temperature and is easy to generate devitrification.

In the production method of the present invention, the glass melt is formed in the fusion process without contacting a zirconia-containing member. This can suppress occurrence of defects in a glass.

To mold the glass melt without contacting the zirconia-containing member in the fusion process, a zirconia-free member is used as a member contacting the glass melt. The specific examples thereof include that a platinum member is used as a blade in the fusion process, and a zirconia component-free refractory is used in the fusion pipe.

The method for producing a cover glass for flat panel displays of the present invention is not particularly limited except that a zirconia-free member is used as a member contacting a glass melt in the fusion process, and can appropriately be selected. Typically, the conventionally known processes can be applied.

For example, raw materials of each component are prepared so as to obtain the composition described hereinafter, and melted by heating in a glass melting furnace. The resulting glass is homogenized by bubbling, stirring, addition of a refining agent, and the like, molded into a glass sheet having a predetermined thickness by a fusion process, and then annealed.

If necessary, the molded glass is subjected to grinding and polishing treatment, subjected to chemical strengthening treatment, washed and then dried.

[Composition of Glass before Chemical Strengthening]

The composition of a glass to be subjected to chemical strengthening treatment preferably contains SiO₂, Al₂O₃, Li₂O, Na₂O, K₂O, MgO and CaO.

SiO₂ is an essential component which forms a glass network. The content (mol %) of SiO₂ in the glass before chemical strengthening is preferably 50% or more to obtain a thermally stable glass, and is preferably 80% or less to make viscosity at the time of melting appropriate. The content thereof is more preferably 55 to 75%.

Al₂O₃ is a component which has the effect of increasing weather resistance and Young's modulus, and further improves ion exchangeability of a glass surface. The content (mol %) of Al₂O₃ in the glass before chemical strengthening is preferably 2% or more from the standpoints of improving weather resistance and increasing t and S in the chemical strengthening, and is preferably 25% or less from the standpoint of appropriately maintaining viscosity at the time of melting. The content thereof is more preferably 4 to 20%.

Li₂O is a component which accelerates melting of raw materials, and is an optional component. The content (mol %) of Li₂O in the glass before chemical strengthening is preferably 0 to 10%, and more preferably 0 to 5%.

Na₂O is a component which chemically strengthens a glass by mainly substituting with potassium ions in an ion-exchange treatment, and additionally controls a thermal expansion coefficient and increases meltability and formability of a glass by decreasing viscosity of the glass at high temperature, and is an optional component. The content (mol %) of Na₂O in the glass before chemical strengthening is preferably 0 to 18%, and more preferably 1 to 16%, from the standpoint of maintaining weather resistance of a glass.

K₂O is a component which accelerates melting of raw materials, and is an optional component. The content (mol %) of K₂O in the glass before chemical strengthening is preferably 0 to 10%, and more preferably 0 to 8%.

MgO is a component which makes a glass difficult to be scratched and improves meltability of a glass, and is an optional component. The content (mol %) of MgO in the glass before chemical strengthening is preferably 0 to 15%, and more preferably 1 to 13%, from the standpoint of maintaining a devitrification temperature at a temperature necessary for forming.

CaO is a component which accelerates melting of raw materials and improves weather resistance, and is an optional component. In the case that the content (mol %) of CaO in the glass before chemical strengthening is too large, such an amount impairs chemical strengthening characteristics. Therefore, the content of CaO is preferably 0 to 5%, and more preferably 0 to 4%.

ZrO₂ is a component which improves ion exchange rate and improves chemical durability and hardness of a glass, and is an optional component. However, as described above, the zircon becomes zirconia crystal, and the zirconia crystal becomes the cause of contaminations in a completed glass sheet. For this reason, the content (mol %) of ZrO₂ in the glass before chemical strengthening is preferable as approaching 0 mol %. Therefore, the content thereof is preferably 5 mol % or less, and more preferably 1.0 mol % or less.

### [Chemical Strengthening]

The chemical strengthening treatment means a treatment of substituting alkali ions having small ion radius (such as sodium ion) on the surface of a glass with alkali ions having large ion radius (such as potassium ion). For example, the chemical strengthening treatment can be carried out by treating a glass containing sodium ion with a melting treatment salt containing potassium ion. By conducting the ion-exchange treatment, the composition of the compression stress layer on the surface of a glass slightly differs from the composition before the ion-exchange treatment, but the composition of the deep layer section of a substrate is nearly the same as the composition before the ion-exchange treatment.

### [Molten Salt]

In the case of using the glass having the above composition as a glass to be subjected to chemical strengthening, examples of the molten salt for conducting the chemical strengthening treatment include alkali sulfates or alkali chlorides, such as potassium nitrate, sodium sulfate, potassium sulfate, sodium chloride and potassium chloride. Those molten salts may be used alone or as mixtures of two or more kinds thereof.

### [Conditions of Chemical Strengthening Treatment]

In the present invention, the treatment conditions of the chemical strengthening treatment are not particularly limited, and can appropriately be selected from the conventional methods.

### (1) Heating Temperature of Molten Salt

The heating temperature of the molten salt is preferably 350° C. or higher, and more preferably 380° C. or higher. Furthermore, the heating temperature thereof is preferably 500° C. or lower, and more preferably 480° C. or lower.

When the heating temperature of the molten salt is lower than 350° C., chemical strengthening is difficult to be achieved due to the decrease in ion-exchange rate. On the other hand, when the heating temperature is 500° C. or lower, decomposition and degradation of the molten salt can be suppressed.

### (2) Treatment Time

The time of contacting a glass with a molten salt is preferably 1 hour or more, and more preferably 2 hours or more, to impart sufficient compression stress to a glass. In the ion exchange for a long period of time, productivity is decreased and compression stress value is decreased by relaxation. Therefore, the contact time is preferably 24 hours or less, and more preferably 20 hours or less.

The cover glass of the present invention preferably has a thickness of 1.5 mm or less and a size of 22 inches or more in diagonal angle. That is, the cover glass of the present invention has the advantages that even though the thickness is decreased as being 1.5 mm or less and a size is a large area as being 22 inches or more in diagonal, the glass has sufficient strength and is difficult to be spontaneously destroyed, whereby appearance and an display quality of displays can be improved. The typical size thereof is 32 inches or more in diagonal.

The cover glass of the present invention is used as a cover glass of flat panel displays.

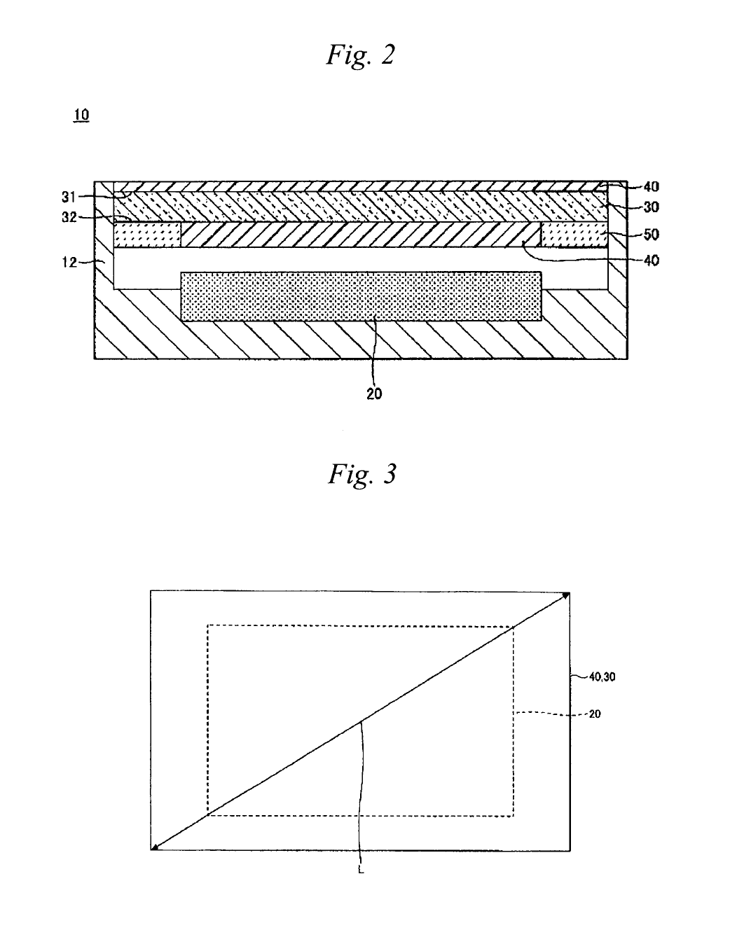

FIG. 2 is a schematic side view of a flat panel display (hereinafter simply referred to as a “display”) in one embodiment of the present invention. As shown in FIG. 3, a display 10 has a display panel 20 and a cover glass 30.

The cover glass 30 is mainly provided for the purpose of improvement in appearance and strength of the display 10, prevention of impact damage, and the like. The cover glass 30 is arranged in front of the display panel 20.

For example, as shown in FIG. 2, the cover glass 30 is arranged so as to separate (so as to have a layer of air) from the display side (front side) of the display panel 20. In this case, the cover glass 30 and the display panel 20 may be integrated through a housing 12.

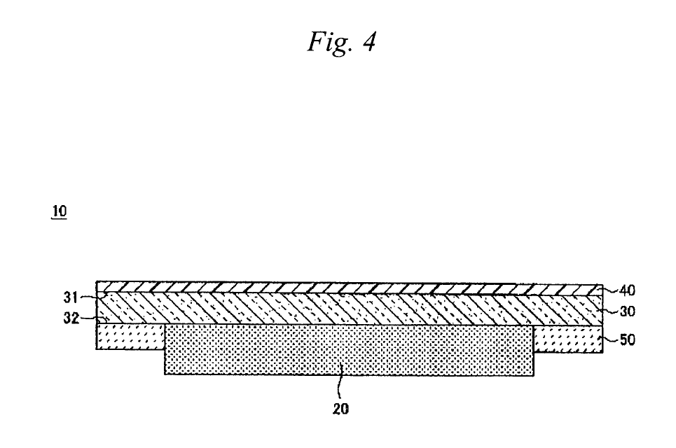

As shown in FIG. 4, the cover glass 30 may be adhered to the display side (front side) of the display panel 20. For example, the cover glass 30 is adhered to the display side of the display panel 20 through an adhesive film (not shown) having translucency. The adhesive film may have a general constitution, and a material and a shape thereof are appropriately selected.

By forming a constitution that a space is not present between the cover glass 30 and the display panel 20 as shown in FIG. 4, reflection of light at the interface between the cover glass 30 (or the display panel 20) and a space can be inhibited. As a result, image quality of the display 10 can be increased. Furthermore, the constitution can contribute to reduction in thickness of the display 10.

The cover glass 30 has a front surface 31 which outgoes light from the display panel 20, and a back surface 32 at which light from the display panel 20 enters. The front surface 31 and/or the back surface 32 may be provided with a functional film 40. The functional film 40 is provided at the front surface 31 and the back surface 32 in FIG. 2, and is provided at the front surface 31 in FIG. 4.

The functional film 40 has the functions such as reflection prevention of ambient light, impact damage prevention, electromagnetic wave shielding, near-infrared ray shielding, color compensation and/or scratch resistance improvement. The functional film 40 is formed by, for example, adhering a resin-made film to the cover glass 30. Alternatively, the functional film 40 may be formed by a thin film formation method such as a vacuum deposition method, a sputtering method and a CVD method. The functional film 40 may has a general constitution, and a thickness and a shape thereof are appropriately selected according to the uses.

A decorative layer 50 is provided on the back surface 32 of the cover glass 30 along at least a part of the periphery thereof. The decorative layer 50 may be arranged so as to surround the outer periphery of the display panel 20. The decorative layer 50 is arranged to increase design and decoration of the cover glass sheet 30 and eventually, the display 10.

For example, when the decorative layer 50 is colored black, light is not emitted at all from the front surface 31 of the cover glass 30 including the periphery of the cover glass 30 when the display 10 is off-state. Therefore, the appearance of the display 10 gives sharp impression to users, and the appearance thereof is improved.

A formation method of the decorative layer 50 is not particularly limited. For example, the formation method includes a method of applying an ink containing pigment particles to the cover glass 30, irradiating the coating with ultraviolet rays or heating and firing the coating, and then cooling.

The pigment particle is constituted of an organic pigment, an inorganic pigment or the like, and the pigment particles are mixed with an organic vehicle and dispersed therein, thereby preparing an ink.

### Examples

The present invention is described below by reference to Examples, but it should be understood that the invention is not construed as being limited thereto.

Particle size (diameter) of defects in a glass (composition (mol %): SiO₂ 66.6%, Al₂O₃ 10.8%, Na₂O 13.2%, K₂O 2.4%, MgO 6.2%, CaO 0.6%) produced by a fusion process was measured using optical microphotographs of 38 samples, and frequency in each particle size range was calculated. The particle size of the defects was measured by comparing the length in the maximum part with the photograph of an objective micrometer. The results are shown in a bar graph of FIG. 1.

Incidence of cracks in the glass was measured. The incidence of cracks was measured by visually judging as to whether or not cracks are generated in a microphotograph. The results are shown in a line graph of FIG. 1.

As shown in the line graph of FIG. 1, the incidence of cracks was rapidly increased when the particle size (diameter) of the defects is 40 μm or more. As a result of analyzing the composition of the defects with EPMA, the defect was ZrO₂. It was found from this result that if defects having a particle size of 40 μm or more are not present in a glass to be chemically strengthened, the possibility of causing spontaneous destruction when chemically strengthened is very low.

The present application is based on Japanese Patent Application No. 2010-280467 filed on Dec. 16, 2010, and the contents are incorporated herein by reference.

### DESCRIPTION OF REFERENCE NUMERALS AND SIGNS

10 Display
20 Display panel
30 Cover glass
31 Front surface
32 Back surface
40 Functional film
50 Decorative layer

What is claimed is:

1. A cover glass for flat panel displays, obtained by chemically strengthening a glass obtained by a fusion process,
wherein the glass before chemical strengthening does not contain defects having a particle size of 40 μm or more, and
the cover glass has an internal tensile stress of 30 MPa or more and a thickness of 1.5 mm or less.

2. The cover glass for flat panel displays according to claim 1, wherein the glass before chemical strengthening contains ZrO₂ in an amount of 1.0% or less in terms of mol %.

3. The cover glass for flat panel displays according to claim 1, wherein the glass before chemical strengthening is a glass containing 50 to 80% of SiO₂, 2to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂ in terms of mol %.

4. A flat panel display using the cover glass for flat panel displays according to claim 1 as a cover glass.

5. A method for producing a cover glass for flat panel displays by chemically strengthening a glass obtained by a fusion process,
wherein the glass before chemical strengthening does not contain defects having a particle size of 40 μm or more, and
the cover glass has an internal tensile stress of 30 MPa or more and a thickness of 1.5 mm or less.

6. The method for producing a cover glass for flat panel displays according to claim 5, wherein the glass before chemical strengthening contains ZrO₂ in an amount of 1.0% or less in terms of mol %.

7. The method for producing a cover glass for flat panel displays according to claim 5, wherein the glass before chemical strengthening is a glass containing 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂ in terms of mol %.
